(19) United States
(12) Patent Application Publication
(10) Pub. No.: US 2026/0058298 A1
(43) Pub. Date: Feb. 26, 2026

(54) POWER BATTERY PACK AND ELECTRICAL DEVICE

(71) Applicant: SVOLT ENERGY TECHNOLOGY CO., LTD., CHANGZHOU (CN)

(72) Inventors: XIANGYANG ZHAO, CHANGZHOU (CN); ZHIQIANG MENG, CHANGZHOU (CN); LIANG ZHAO, CHANGZHOU (CN); CHUANSHENG CHENG, CHANGZHOU (CN)

(73) Assignee: SVOLT ENERGY TECHNOLOGY CO., LTD., CHANGZHOU (CN)

(21) Appl. No.: 18/850,343

(22) PCT Filed: Dec. 25, 2023
(86) PCT No.: PCT/CN2023/141654

§ 371 Date: Sep. 24, 2024

(30) Foreign Application Priority Data
Dec. 23, 2022 (CN) 202223470196.X

(51) Int. Cl. H01M 50/367; H01M 10/613; H01M 10/6554; H01M 10/658; H01M 50/204; H01M 50/289; H01M 50/342

(52) U.S. Cl. CPC H01M 50/367; H01M 10/613; H01M 10/6554; H01M 10/658; H01M 50/289; H01M 50/3425; H01M 50/204

(57) ABSTRACT

Provided is a power battery pack and electrical device. The power battery pack includes a support plate provided with pressure relief grooves, each of the pressure relief grooves is sequentially provided with a plurality of pressure relief cavities along a length direction thereof, and each of the pressure relief cavities is provided with at least one pressure relief hole on each side wall of two opposite sides of corresponding one of the pressure relief grooves; modules, each of the modules includes a plurality of battery cells arranged in sequence, each of the battery cells corresponds to one of the pressure relief cavities, and each of the battery cells is provided with an explosion-proof valve partially located in corresponding one of the pressure relief cavities.

### CROSS-REFERENCE OF RELATED APPLICATION

This application claims priority of Chinese Patent Application No. 202223470196.X, filed on Dec. 23, 2022, the contents of which are hereby incorporated by reference.

### TECHNICAL FIELD

The disclosure relates to the technical field of power batteries, in particular to a power battery pack and an electrical device.

### BACKGROUND

A battery is a device that can convert chemical energy into electrical energy, where a battery pack is a constituent unit of the battery, and a plurality of battery cells are arranged in the battery pack.

At present, for the battery pack of the battery cells with pressure relief valves at the bottom, the battery pack can only be depressurized through the whole package pressure relief valve, or the battery pack is isolated into a pressure relief cavity for pressure relief, and the overall pressure relief of the battery pack will increase the probability of thermal spread of the battery cells in adjacent modules, which is easy to cause the overall thermal runaway.

### SUMMARY

Therefore, the technical problem to be solved by the disclosure is to overcome the defect that the overall pressure relief of the battery pack in the prior art leads to an increase in the probability of thermal spread of the battery cells in the adjacent modules, thereby providing a power battery pack for reducing the thermal spread of the battery cells in the adjacent modules.

In order to solve the above problems, the disclosure provides a power battery pack, which includes: a support plate provided with pressure relief grooves; each of the pressure relief grooves is sequentially provided with a plurality of pressure relief cavities along a length direction thereof, and each of the pressure relief cavities is provided with at least one pressure relief hole on each side wall of two opposite sides of corresponding one of the pressure relief grooves; modules, each of the modules includes a plurality of battery cells arranged in sequence, each of the battery cells corresponds to one of the pressure relief cavities, and each of the battery cells is provided with an explosion-proof valve partially located in corresponding one of the pressure relief cavities.

In some embodiments, a thermal insulation pad is arranged between two adjacent the battery cells, and the thermal insulation pad extends into corresponding one of the pressure relief grooves and abuts against an inner wall of corresponding one of the pressure relief grooves, so that two adjacent thermal insulation pads separate corresponding one of the pressure relief cavities in each of the pressure relief grooves.

In some embodiments, the support plate has a structure of a plate body, and a part of the plate body of the support plate is concave to form the pressure relief grooves, and the modules are attached with a part of the support plate protruding relative to the pressure relief grooves.

In some embodiments, an area of a cross section of the pressure relief hole gradually decreases in a direction from the inner wall to an outer wall of corresponding one of the pressure relief grooves, and the cross section of the pressure relief hole is a cross section perpendicular to a center of the pressure relief hole.

In some embodiments, the pressure relief hole is provided with a one-way membrane structure or a one-way valve.

In some embodiments, the power battery pack further includes a first cooling plate, the first cooling plate is provided with avoidance grooves, one end of each of the avoidance grooves is provided with a baffle, each of the pressure relief grooves penetrates corresponding one of the avoidance grooves and causes the baffle to shield one end of corresponding one of the pressure relief grooves, and the pressure relief hole avoids corresponding one of the avoidance grooves, the first cooling plate is connected with the support plate.

In some embodiments, the first cooling plate includes: a runner plate provided with a first groove; a cooling flat plate provided with a second groove, wherein the cooling flat plate is buckled on the runner plate so that the second groove is opposite with the first groove to form the avoidance grooves.

In some embodiments, the power battery pack further includes a second cooling plate, the second cooling plate and the first cooling plate are arranged on opposite sides of each of the modules.

In some embodiments, the power battery pack further includes a bottom guard plate, the bottom guard plate abuts against an outer wall of a bottom of each of the pressure relief grooves and causes each of the pressure relief grooves to form a pressure relief channel along opposite two sides of a width direction.

The disclosure also provides an electrical device, which includes a power battery pack, the power battery pack is configured as the power battery packs described above.

The disclosure has the following advantages.

1. The pressure relief cavity formed by the battery cell and the pressure relief groove can accommodate part of the explosion-proof valve, and the opening position of the pressure relief hole is far away from the explosion-proof valve. When a single battery cell has thermal runaway, the high temperature gas can only be discharged through the pressure relief hole on the side wall, which can effectively protect the electrical assembly, water cooling pipeline and other parts in the box body.

2. An independent pressure relief cavity is formed by attaching the thermal insulation pad with the inner wall of the pressure relief groove, which can play a good protective role.

3. The pressure relief hole is trumpet-shaped or a one-way valve or one-way membrane structure is arranged at the pressure relief hole, which reduces the influence of thermal runaway on adjacent battery cells.

4. By arranging the first cooling plate at the bottom, the battery cells can be cooled and the cooling efficiency is improved.

5. By arranging the second cooling plate at the top, the second cooling plate cooperates with the first cooling plate, which can form a dual cooling effect on the modules, and further improve the cooling efficiency.

6. By adding the bottom guard plate, it not only further supports the support plate, but also forms a pressure relief channel, so that hot gas can be discharged from the pressure relief channel, which is beneficial to the treatment of the discharged gas, thus optimizing the ambient air.

### BRIEF DESCRIPTION OF THE DRAWINGS

In order to explain the specific embodiment of the disclosure or the technical scheme in the prior art more clearly, the drawings needed in the description of the specific embodiment or the prior art will be briefly introduced below. Apparently, the attached drawings in the following description are some embodiments of the disclosure, and for those skilled in the art, other drawings can be obtained according to these drawings without creative efforts.

FIG. 1 is a schematic diagram of the explosion structure of a power battery pack according to an embodiment of the disclosure;

FIG. 2 is a perspective schematic structural diagram of a support plate of the power battery pack according to an embodiment of the disclosure;

FIG. 3 is a perspective schematic structural diagram of the power battery pack according to an embodiment of the disclosure;

FIG. 4 is a perspective schematic structural diagram of the power battery pack showing pressure relief grooves according to an embodiment of the disclosure;

FIG. 5 is a schematic diagram of the explosion structure of the power battery pack according to another embodiment of the disclosure;

FIG. 6 is a perspective schematic structural diagram of a first cooling plate of the power battery pack according to another embodiment of the disclosure;

FIG. 7 is schematic structural diagram in a top view of a runner plate of the power battery pack according to another embodiment of the disclosure;

FIG. 8 is schematic structural diagram in a top view of a cooling flat plate of the power battery pack according to another embodiment of the disclosure; and

FIG. 9 is a perspective schematic structural diagram of the power battery pack without a second cooling plate installed according to another embodiment of the disclosure.

List of reference characters: 100 power battery pack; 110 support plate; 111 pressure relief groove; 113 pressure relief hole; 115 pressure relief channel; 117 pressure relief cavity; 120 module; 121 battery cell; 123 thermal insulation pad; 125 explosion-proof valve; 127 module end plate; 130 bottom guard plate; 140 box body; 141 transverse partition plate; 143 longitudinal partition plate; 1401 side gap; 150 isolation part; 160 module pressure relief valve; 170 electrical assembly; 180 box body pressure relief valve; 191 first cooling plate; 1911 runner plate; 1913 cooling flat plate; 193 second cooling plate; 1901 avoidance groove; and 1903 baffle.

### DETAILED DESCRIPTION OF PREFERRED EMBODIMENTS

The technical solution of the disclosure will be clearly and completely described in combination with the attached drawings. Apparently, the described embodiment is a part of the embodiment of the disclosure, but all of the embodiment. Based on the embodiments in the disclosure, all other embodiments obtained by those skilled in the field without creative efforts belong to the scope of protection in the disclosure.

### Example Power Battery Pack

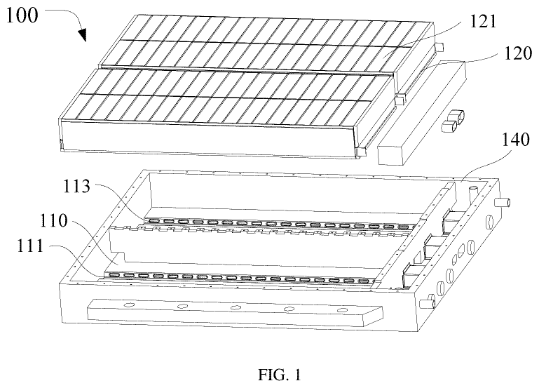

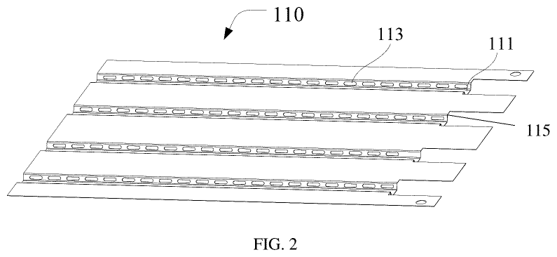

As shown in FIGS. 1 to 3, a power battery pack 100 is provided and includes a support plate 110 and modules 120. The support plate 110 is provided with pressure relief grooves 111; each of the pressure relief grooves 111 is sequentially provided with a plurality of pressure relief cavities 117 along a length direction thereof, and each of the pressure relief cavities 117 is provided with at least one pressure relief hole 113 on each side wall of two opposite sides of corresponding one of the pressure relief grooves 111. Each of the modules includes a plurality of battery cells 121 arranged in sequence, each of the battery cells 121 corresponds to one of the pressure relief cavities 117, and each of the battery cells 121 is provided with an explosion-proof valve 125 partially located in corresponding one of the pressure relief cavities 117.

The thickness of the support plate 110 mentioned above is uniform, and the pressure relief groove 111 extends from the first side of the support plate 110 to the opposite second side, in which the first side is opposite to the second side. The pressure relief groove 111 has a groove bottom and two opposite side walls, and the pressure relief holes 113 are arranged on the side walls, and the pressure relief holes 113 are arranged close to the groove bottom. A plurality of pressure relief holes 113 are sequentially arranged along the length direction of the pressure relief groove 111. The module 120 includes a plurality of battery cells 121, and the bottom of each battery cell 121 is provided with an explosion-proof valve 125. When the modules 120 are placed on the support plate 110, a plurality of battery cells 121 are arranged along the length direction of the pressure relief groove 111, so that the explosion-proof valve 125 of each battery cell 121 is opposite to the pressure relief groove 111. When the battery cells 121 abut against the support plate 110, the pressure relief cavity 117 formed by the module 120 and the pressure relief groove 111 can accommodate part of the explosion-proof valve 125. The opening position of the pressure relief hole 113 is far away from the explosion-proof valve 125. When a single battery cell 121 has the thermal runaway, because a sealed and independent pressure relief cavity 117 has been formed at the position of the explosion-proof valve 125 of the runaway battery cell, high temperature gas can only be discharged to both sides through the pressure relief hole 113 on the side wall of the pressure relief groove 111. Therefore, the electrical assembly, water cooling pipeline and other parts in the box body are effectively protected.

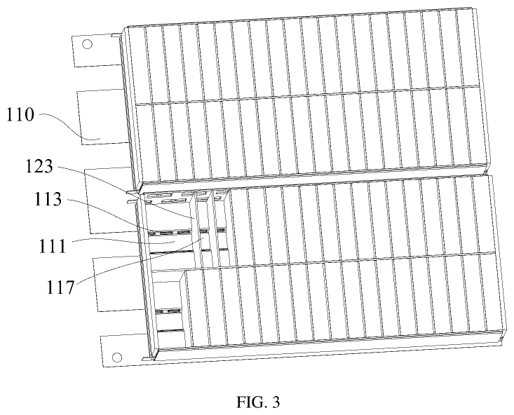

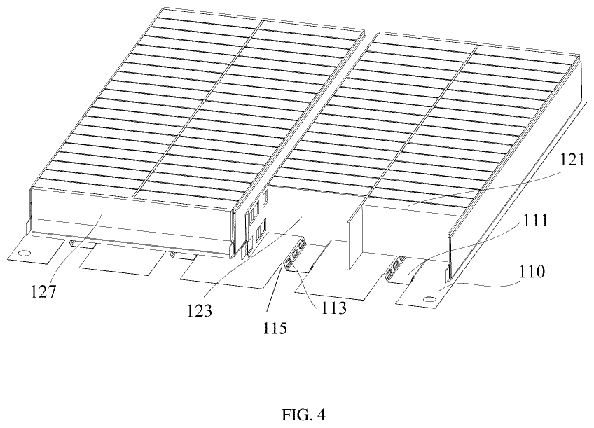

Optionally, as shown in FIGS. 3 and 4, a thermal insulation pad 123 is arranged between two adjacent the battery cells 121, and the thermal insulation pad 123 extends into corresponding one of the pressure relief grooves 111 and abuts against an inner wall of corresponding one of the pressure relief grooves 111, so that two adjacent thermal insulation pads 123 separate corresponding one of the pressure relief cavities 117 in each of the pressure relief grooves 111.

As shown in FIG. 4, the bottom of the thermal insulation pad 123 mentioned above protrudes to form a protruding structure, and the protruding structure of the thermal insulation pad 123 is attached to the side walls of both sides and the bottom wall of the pressure relief groove 111, thereby forming an independent pressure relief cavity 117 of a single battery cell. Although there is also pressure relief hole 113 in the pressure relief cavity 117 corresponding to the adjacent battery cell 121, the pressure relief cavity 117 corresponding to the adjacent battery cell 121 is sealed, so the high temperature gas is difficult to enter and be discharged along the pressure relief channels 115 on both sides.

Optionally, the support plate 110 has a structure of a plate body, and a part of the plate body of the support plate 110 is concave to form the pressure relief grooves 111, and the modules 120 are attached with a part of the support plate 110 protruding relative to the pressure relief grooves 111.

The above-mentioned pressure relief groove 111 can be formed by the support plate 110 being concave to one side face of the support plate, and the two opposite sides of the pressure relief groove 111 are protruded relative to the pressure relief groove 111, and the protruded part has a plane, which can be used for bonding with the battery cells 121 of the module 120.

Optionally, an area of a cross section of the pressure relief hole 113 gradually decreases in a direction from the inner wall to an outer wall of corresponding one of the pressure relief grooves 111, and the cross section of the pressure relief hole 113 is a cross section perpendicular to a center of the pressure relief hole 113.

The area of the cross-section of the above-mentioned pressure relief hole 113 gradually decreases in a direction from the inner side wall to the outside of the pressure relief groove 111, so that the pressure relief hole 113 has a trumpet-shaped structure. Specifically, the area of the cross section of the inner side wall, close to the pressure relief groove 111, of the pressure relief hole 113 is larger than that of the inner side wall, far away from the pressure relief groove 111, of the pressure relief hole 113. The cross section of the pressure relief hole 113 is a plane perpendicular to the center line of the pressure relief hole 113. The pressure relief hole 113 can be an elongated hole, and the trumpet shape of the pressure relief hole 113 will increase the difficulty for hot gas to enter the pressure relief cavity 117 corresponding to the pressure relief hole 113 from the outside, so that the hot gas will not be discharged to the adjacent battery cell 121 after the thermal runaway of a single battery cell 121.

Optionally, the pressure relief hole 113 is provided with a one-way membrane structure or a one-way valve. The one-way membrane structure is made of mica, and the gas in the pressure relief cavity 117 can break through the one-way membrane structure and be discharged to the outside, but it cannot escape back. In addition, the one-way membrane structure can also be replaced by a one-way valve, so that gas can only be discharged from the inside of the pressure relief cavity 117 through the one-way membrane structure, but not to the pressure relief cavity 117 through the one-way membrane structure. Therefore, it can also increase the difficulty for hot gas to enter the pressure relief cavity 117 corresponding to the pressure relief hole 113 from the outside.

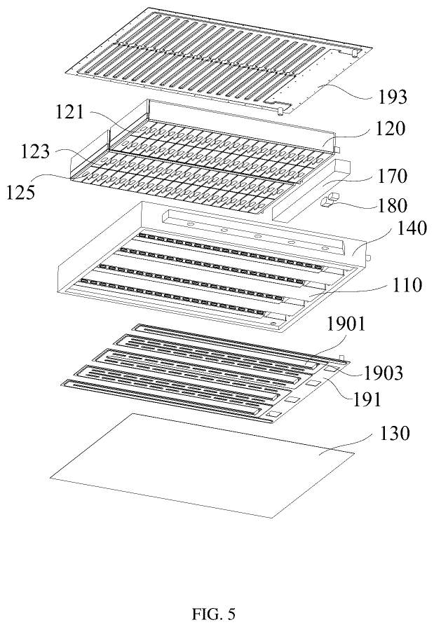

Optionally, as shown in FIG. 5, the power battery pack further includes a first cooling plate 191, the first cooling plate 191 is provided with avoidance grooves 1901, one end of each of the avoidance grooves 1901 is provided with a baffle 1903, each of the pressure relief grooves 111 penetrates corresponding one of the avoidance grooves 1901 and causes the baffle 1903 to shield one end of corresponding one of the pressure relief grooves 111, and the pressure relief hole 113 avoids corresponding one of the avoidance grooves 1901, the first cooling plate 191 is connected with the support plate 110.

The above-mentioned first cooling plate 191 can be a water cooling plate, and the first cooling plate 191 can be bonded with the support plate 110 through a thermal conducting structure to cool the battery cells 121. The avoidance grooves 1901 arranged on the first cooling plate 191 correspond to the pressure relief grooves 111 one by one, and the first cooling plate 191 can be connected with the support plate 110 in an adhesive manner. The avoidance groove 1901 is sleeved outside the pressure relief groove 111, and the pressure relief hole 113 avoids the side wall of the avoidance groove 1901, so that the pressure relief hole 113 can discharge gas. One end of the avoidance groove 1901 is provided with a baffle 1903, which can seal and block one end of the pressure relief groove 111, and the other end of the pressure relief groove 111 can abut against the side wall of the box body 140, so that the pressure relief groove 111 can form a sealed groove. The modules 120 can be cooled by the first cooling plate 191, and the quality of the power battery pack 100 can be improved.

The first cooling plate 191 can be turned over by blocking, which can prevent other impurities from being discharged into the space between the support plate 110 and the bottom guard plate 130. Corresponding to the pressure relief groove 111, a module pressure relief valve 160 and a box body pressure relief valve 180 may be provided on the side wall of the box body 140.

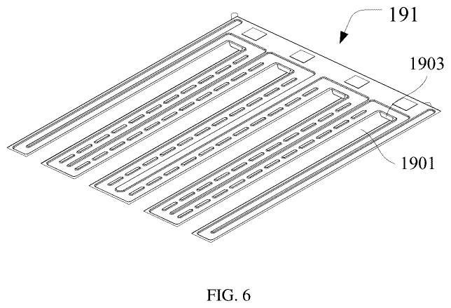

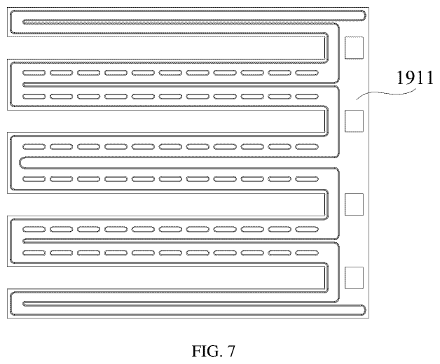

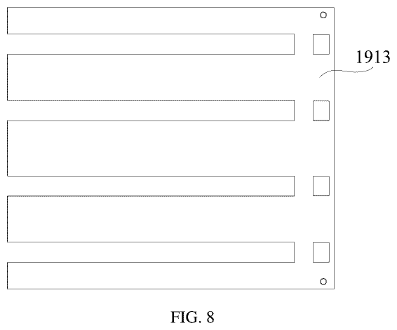

Optionally, as shown in FIGS. 6, 7, and 8, the first cooling plate 191 includes a runner plate 1911 and a cooling flat plate 1913. The runner plate 1911 is provided with a first groove, the cooling flat plate 1913 is provided with a second groove, the cooling flat plate 1913 is buckled on the runner plate 1911, so that the second groove is opposite with the first groove to form the avoidance groove 1901.

The above-mentioned cooling flat plate 1913 can be used to support the support plate 110. The runner plate 1911 and the cooling flat plate 1913 can be made of aluminum, and the support plate 110 is made of steel plate.

As shown in FIG. 5, the power battery pack further includes a second cooling plate 193, the second cooling plate 193 and the first cooling plate 191 are arranged on opposite sides of each of the modules 120.

The above-mentioned second cooling plate 193 can be a water cooling plate or a flat plate. The second cooling plate 193 is bonded to the modules 120, and the second cooling plate 193 is arranged opposite to the first cooling plate 191, which can form double cooling for the modules 120 and has better cooling effect.

Optionally, as shown in FIG. 5, the power battery pack further includes a bottom guard plate 130, the support plate 110 is arranged on the bottom guard plate 130, and a pressure relief channel 115 is formed between the bottom guard plate 130 and the support plate 110.

It can be understood that the bottom guard plate 130 and the support plate 110 are plate-like structures respectively, and the plate surface of the bottom guard plate 130 can be plane, and the outer surface of the bottom wall of the pressure relief groove 111 also has a plane, so that the bottom wall of the pressure relief groove 111 can be easily bonded with the bottom guard plate 130. The outer surface of the groove bottom of the pressure relief groove 111 of the support plate 110 is attached with the bottom guard plate 130 each other, and the parts, located at the opposite sides of the pressure relief groove 111, of the support plate 110 protrude in a direction away from the bottom guard plate 130 respectively. Thus, a pressure relief channel 115 is formed between the support plate 110 and the bottom guard plate 130, and the trumpet shape of the pressure relief hole 113 makes the hot gas entering the pressure relief channel 115 avoid or reduce its entry into other pressure relief cavities 117, so that the hot gas can be discharged along the pressure relief channels 115 on both sides.

The pressure relief channel 115 is provided on at least one of the two opposite sides of the pressure relief groove 111, and extends from the first side to the second side of the support plate 110. The protruding part of the support plate 110 relative to the pressure relief groove 111 is arranged away from the bottom guard plate 130 and forms a bottom gap with the bottom guard plate 130, and the bottom gaps on the opposite sides of the pressure relief groove 111 form a pressure relief channel 115. The protruding part of the support plate 110 relative to the pressure relief groove 111 has a protruding plane abutting against the battery cell 121, so that the module 120 can be supported on the support plate 110. The groove bottom of the groove can also be plane, which is beneficial for the support plate 110 to be supported on the bottom guard plate 130.

Of course, if the bottom guard plate 130 is removed, only the support plate 110 can protect the modules 120, and at the same time, the one-way membrane structure or one-way valve can isolate the explosion-proof valve 125 from the external space. In this way, if a single battery cell 121 has thermal runaway, the hot gas can be directly discharged to the atmosphere outside the pressure relief cavity 117.

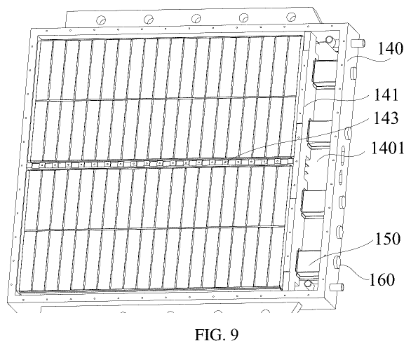

Optionally, as shown in FIGS. 1 and 9, the power battery pack also includes a box body 140, and a transverse partition plate 141 is arranged in the box body 140. The transverse partition plate 141 divides an accommodating cavity and a side gap 1401 in the box body 140, and the accommodating cavity is provided with modules 120, and the side gap 1401 is provided with an electrical assembly 170.

The above-mentioned box body 140 has a cubic structure, and a transverse partition plate 141 and a longitudinal partition plate 143 are arranged in the box body 140, and the longitudinal partition plate 143 divides two areas in the accommodating cavity, and each area is provided with a module 120.

Optionally, as shown in FIG. 9, the power battery pack further includes isolation parts 150 and module pressure relief valves 160. The isolation parts 150 are arranged in the side gap 1401, the isolation part 150 are buckled with the pressure relief groove 111, the end face of one end of the isolation part 150 abuts against the transverse partition plate 141, and the end face of the other opposite end of the isolation part 150 abuts against the inner wall of the box body 140. The module pressure relief valves 160 are arranged on the box body 140, and the module pressure relief valve 160 is arranged corresponding to the pressure relief groove 111. The electrical assembly 170 abuts against the isolation part 150.

The above-mentioned isolation part 150 is used to extend the pressure relief groove 111 corresponding to the battery cell 121 in the side gap 1401. By arranging the modular pressure relief valve 160 corresponding to the pressure relief groove 111 on the box body 140, the modular pressure relief valve 160 can relieve the gas entering the pressure relief groove 111.

Optionally, as shown in FIG. 5, the power battery pack further includes a box body pressure relief valve 180, which is arranged on the box body 140 and is suitable for relieving the pressure of the box body 140.

The above-mentioned box body pressure relief valve 180 can relieve the exhaust gas and pressure discharged from the gap of the independent channel.

The above-mentioned battery pack mainly includes the bottom guard plate 130, the support plate 110, the modules 120, the box body 140, the isolation part 150, an electrical assembly 170, high and low voltage connectors, the pressure relief valve, the first cooling plate 191 and the second cooling plate 193.

As shown in FIG. 9, the box body 140 is provided with the transverse partition plate 141 and the longitudinal partition plate 143 in the middle. The basic installation process is inverted: after the pressure relief valve, water cooling pipe joint and other components are pre-installed in the box body 140, the second cooling plate 193 is installed first; the thermal conducting structural adhesive is coated on the diversion channel position of the second cooling plate 193, the assembled modules 120 are hoisted into the box body for press-fitting and curing, and then the electrical devices and water cooling pipelines in the box body 140 are installed; then, structural adhesive is coated at the corresponding position of the contact surface between the bottom of the battery cell 121 and the support plate 110; then, the bottom assembly which has welded the support plate 110 to the bottom guard plate 130 is installed, and the bolts are fastened/FDS is fastened, and press-fitting and curing is performed. Of course, after the installation of the module 120 is completed, the separate support plate 110 can be glued to the bottom of the module 120, after curing as a whole, and then the whole is put into the box body through the lifting holes on the lifting plate for gluing and curing, and then the contact surface between the support plate 110 and the bottom guard plate 130 is coated with structural adhesive, the first cooling plate 191 is installed, and finally the bottom guard plate 130 is installed, this method is full gluing. The isolation part 150 can be installed separately for final installation or integrated into the box body 140. After installation, there are gaps in the independent channels of the module 120, which can not be completely sealed. The exhaust gas will discharge the flame but will not pass through the narrow gap, and the pressure will be released through the box body pressure relief valve 180 in the space of the box body 140.

The basic structure of module 120 includes the battery cells 121, the thermal insulation pad 123 between battery cells 121, partition plates, module end plates 127, CCS assembly and CCS assembly protection cover, and CCS assembly includes bus bar, FPC and bracket, or includes bus bar, FFC and PET fixing membrane.

The thickness of the support plate 110 is thin spring steel, and the thickness of the support plate 110 is 0.3 mm to 0.8 mm, or a low-strength energy-absorbing plate is used to pre-weld to the bottom guard plate 130. The explosion-proof valve 125 of the battery cell is located in the pressure relief groove 111, forming the pressure relief groove 111 with an independent pressure relief cavity 117, and the side wall of the pressure relief groove 111 is opened, and the opening position is far away from the explosion-proof valve. At the same time, the shape of the opening can be trumpet stretching treatment, in order to reduce the influence of thermal runaway of the battery cell on the adjacent battery cells. At the same time, the bottom of the thermal insulation pad 123 is made into a protruding structure, and the protrusion of the thermal insulation pad is attached to the side wall of the pressure relief groove 111, thus forming an independent battery cell pressure relief cavity 117 of a single battery cell. When a single battery cell has thermal runaway, a sealed independent battery cell pressure relief cavity 117 has been formed at the position of the runaway battery cell pressure relief valve, and high temperature gas can only be discharged to the pressure relief channel 115 through the pressure relief hole 113 on the side wall. Impact on adjacent battery cells: the pressure relief channel 115 and the battery cell 121 are protected by the support plate 110, which reduces the thermal spread. Although the adjacent battery cells also have pressure relief cavity side wall exhaust holes, because the pressure relief cavity 117 of the adjacent battery cells is sealed internally, it is difficult for high temperature gas to enter, and at the same time, the trumpet shape of the pressure relief hole 113 will increase the difficulty for hot gas to enter, so as to be discharged along the pressure relief channel 115. The pressure relief channel 115 has an independent pressure relief valve. The pressure relief channel 115 is formed by the pressure relief isolation part 150 arranged on the box body, and the pressure relief channel 115 is basically sealed, which can effectively protect the electrical assembly, the water cooling pipeline, and other parts in the box body. In addition to the pressure relief valve of the independent channel, a box body pressure relief valve 180 is additionally installed on the box body 140, which can be used to relieve the exhaust gas and the pressure discharged from the gap of the independent channel.

Optionally, the side, facing the bottom guard plate 130, of the second cooling plate 193 is provided with a thermal conducting structure, in which the thermal conducting structure can be attached to the second cooling plate 193 and the modules 120, which is beneficial to the heat dissipation of the modules 120.

Optionally, the thermal conducting structure includes a thermal conducting adhesive membrane, and the thermal conducting adhesive membrane is attached to the side, facing the bottom guard plate 130, of the second cooling plate 193. In which, the material of thermal conducting structural adhesive can be polyurethane thermal conducting structural adhesive or modified epoxy thermal conducting structural adhesive, and the thermal conducting structural adhesive forms a film, the thermal conducting effect is good.

### Example Electrical Device

An electrical device is provided, which includes a power battery pack 100 configured as the power battery pack 100 described above. When the power battery pack 100 is applied to the electrical device, the power battery pack 100 may include a module 120, and the module 120 may include a plurality of battery cells 121.

According to the above description, the disclosure has the following advantages.

1. The explosion-proof valve 125 of the battery cell 121 is opposite to the pressure relief groove 111, the pressure relief cavity 117 formed by the battery cell 121 and the pressure relief groove 111 can accommodate part of the explosion-proof valve, and the opening position of the pressure relief hole 113 is located far away from the explosion-proof valve. When a single battery cell 121 has thermal runaway, a sealed and independent pressure relief cavity 117 has been formed at the position of the explosion-proof valve 125 of the runaway battery cell, and the high temperature gas can only be discharged through the pressure relief hole 113 on the side wall, which can effectively protect the electrical assembly, water cooling pipeline and other parts in the box body.

2. An independent pressure relief cavity 117 is formed by attaching the thermal insulation pad 123 with the inner wall of the pressure relief groove 111, which can play a good protective role.

3. The pressure relief hole 113 is trumpet-shaped or a one-way valve or one-way membrane structure is arranged at the pressure relief hole 113, which reduces the influence of thermal runaway on adjacent battery cells.

4. By arranging the first cooling plate 191 at the bottom, the battery cell can be cooled and the cooling efficiency is improved.

5. By arranging the second cooling plate 193 at the top, the second cooling plate 193 cooperates with the first cooling plate 191, which can form a dual cooling effect on the modules 120, and further improve the cooling efficiency.

6. By adding the bottom guard plate 130, it not only further supports the support plate 110, but also forms a pressure relief channel 115, so that hot gas can be discharged from the pressure relief channel 115, which is beneficial to the treatment of the discharged gas, thus optimizing the ambient air.

In the description of the disclosure, it should be noted that the orientation or positional relationship indicated by the terms “center”, “upper”, “lower”, “left”, “right”, “vertical”, “horizontal”, “inner” and “outer” are based on the orientation or positional relationship shown in the attached drawings, and are only for the convenience of describing the disclosure and simplifying the description, rather than indicating or implying that the referred device or element must have a specific orientation, be constructed and operate in a specific orientation, and therefore cannot be construed as a limitation of the disclosure. In addition, the terms “first”, “second” and “third” are only used for descriptive purposes and cannot be understood as indicating or implying relative importance.

In the description of the disclosure, it should be noted that unless otherwise expressly specified and limited, the terms “installation”, “connect” and “connection” should be broadly understood, for example, they can be fixed connection, can also be detachable connection or integrated connection; can be a mechanical connection, can also be an electrical connection; can be directly connected, can also be indirectly connected through an intermediate medium, and can be the connection inside two elements. For those skilled in the art, the specific meanings of the above terms in the disclosure can be understood according to specific situations.

In addition, the technical features involved in different embodiments of the disclosure described below can be combined with each other as long as they do not conflict with each other.

Apparently, the above-mentioned embodiment is only an example for clear explanation, and is not a limitation of the implementation. For those skilled in the art, other changes or modifications in different forms can be made on the basis of the above description. It is unnecessary and impossible to exhaust all the implementation here. However, apparent changes or modifications arising therefrom are still within the protection scope of the disclosure.

What is claimed is:

1. A power battery pack, comprising:
a support plate provided with pressure relief grooves; wherein each of the pressure relief grooves is sequentially provided with a plurality of pressure relief cavities along a length direction thereof, and each of the pressure relief cavities is provided with at least one pressure relief hole on each side wall of two opposite sides of corresponding one of the pressure relief grooves;
modules; wherein each of the modules comprises a plurality of battery cells arranged in sequence, each of the battery cells corresponds to one of the pressure relief cavities, and each of the battery cells is provided with an explosion-proof valve partially located in corresponding one of the pressure relief cavities.

2. The power battery pack according to claim 1, wherein a thermal insulation pad is arranged between two adjacent the battery cells, and the thermal insulation pad extends into corresponding one of the pressure relief grooves and abuts against an inner wall of corresponding one of the pressure relief grooves, so that two adjacent thermal insulation pads separate corresponding one of the pressure relief cavities in each of the pressure relief grooves.

3. The power battery pack according to claim 1, wherein the support plate has a structure of a plate body, and a part of the plate body of the support plate is concave to form the pressure relief grooves, and the modules are attached with a part of the support plate protruding relative to the pressure relief grooves.

4. The power battery pack according to claim 1, wherein an area of a cross section of the pressure relief hole gradually decreases in a direction from the inner wall to an outer wall of corresponding one of the pressure relief grooves, and the cross section of the pressure relief hole is a cross section perpendicular to a center of the pressure relief hole.

5. The power battery pack according to claim 2, wherein an area of a cross section of the pressure relief hole gradually decreases in a direction from the inner wall to an outer wall of corresponding one of the pressure relief grooves, and the cross section of the pressure relief hole is a cross section perpendicular to a center of the pressure relief hole.

6. The power battery pack according to claim 3, wherein an area of a cross section of the pressure relief hole gradually decreases in a direction from the inner wall to an outer wall of corresponding one of the pressure relief grooves, and the cross section of the pressure relief hole is a cross section perpendicular to a center of the pressure relief hole.

7. The power battery pack according to claim 1, wherein the pressure relief hole is provided with a one-way membrane structure or a one-way valve.

8. The power battery pack according to claim 2, wherein the pressure relief hole is provided with a one-way membrane structure or a one-way valve.

9. The power battery pack according to claim 3, wherein the pressure relief hole is provided with a one-way membrane structure or a one-way valve.

10. The power battery pack according to claim 1, further comprising a first cooling plate, wherein the first cooling plate is provided with avoidance grooves, one end of each of the avoidance grooves is provided with a baffle, each of the pressure relief grooves penetrates corresponding one of the avoidance grooves and causes the baffle to shield one end of corresponding one of the pressure relief grooves, and the pressure relief hole avoids corresponding one of the avoidance grooves, the first cooling plate is connected with the support plate.

11. The power battery pack according to claim 2, further comprising a first cooling plate, wherein the first cooling plate is provided with avoidance grooves, one end of each of the avoidance grooves is provided with a baffle, each of the pressure relief grooves penetrates corresponding one of the avoidance grooves and causes the baffle to shield one end of corresponding one of the pressure relief grooves, and the pressure relief hole avoids corresponding one of the avoidance grooves, the first cooling plate is connected with the support plate.

12. The power battery pack according to claim 3, further comprising a first cooling plate, wherein the first cooling plate is provided with avoidance grooves, one end of each of the avoidance grooves is provided with a baffle, each of the pressure relief grooves penetrates corresponding one of the avoidance grooves and causes the baffle to shield one end of corresponding one of the pressure relief grooves, and the pressure relief hole avoids corresponding one of the avoidance grooves, the first cooling plate is connected with the support plate.

13. The power battery pack according to claim 10, wherein the first cooling plate comprises:
a runner plate provided with a first groove;
a cooling flat plate provided with a second groove, wherein the cooling flat plate is buckled on the runner plate so that the second groove is opposite with the first groove to form the avoidance grooves.

14. The power battery pack according to claim 11, wherein the first cooling plate comprises:
a runner plate provided with a first groove;
a cooling flat plate provided with a second groove, wherein the cooling flat plate is buckled on the runner plate so that the second groove is opposite with the first groove to form the avoidance grooves.

15. The power battery pack according to claim 12, wherein the first cooling plate comprises:
a runner plate provided with a first groove;
a cooling flat plate provided with a second groove, wherein the cooling flat plate is buckled on the runner plate so that the second groove is opposite with the first groove to form the avoidance grooves.

16. The power battery pack according to claim 10, further comprising a second cooling plate, wherein the second cooling plate and the first cooling plate are arranged on opposite sides of each of the modules.

17. The power battery pack according to claim 1, further comprising a bottom guard plate, wherein the bottom guard plate abuts against an outer wall of a bottom of each of the pressure relief grooves and causes each of the pressure relief grooves to form a pressure relief channel along opposite two sides of a width direction.

18. The power battery pack according to claim 2, further comprising a bottom guard plate, wherein the bottom guard plate abuts against an outer wall of a bottom of each of the pressure relief grooves and causes each of the pressure relief grooves to form a pressure relief channel along opposite two sides of a width direction.

19. The power battery pack according to claim 3, further comprising a bottom guard plate, wherein the bottom guard plate abuts against an outer wall of a bottom of each of the pressure relief grooves and causes each of the pressure relief grooves to form a pressure relief channel along opposite two sides of a width direction.

20. An electrical device, comprising a power battery pack, wherein the power battery pack comprises:
a support plate provided with pressure relief grooves; wherein each of the pressure relief grooves is sequentially provided with a plurality of pressure relief cavities along a length direction thereof, and each of the pressure relief cavities is provided with at least one pressure relief hole on each side wall of two opposite sides of corresponding one of the pressure relief grooves;
modules; wherein each of the modules comprises a plurality of battery cells arranged in sequence, each of the battery cells corresponds to one of the pressure relief cavities, and each of the battery cells is provided with an explosion-proof valve partially located in corresponding one of the pressure relief cavities.
